(19) United States
(12) Patent Application Publication
(10) Pub. No.: US 2024/0005219 A1
(43) Pub. Date: Jan. 4, 2024

(54) WORK SPACE ASSIGNMENT

(71) Applicant: Lenovo (Singapore) Pte. Ltd., Singapore (SG)

(72) Inventor: Aaron M. Stewart, Raleigh, NC (US)

(21) Appl. No.: 17/855,103

(22) Filed: Jun. 30, 2022

(51) Int. Cl. G06Q 10/02; G06Q 10/10

(52) U.S. Cl. CPC G06Q 10/02; G06Q 10/1093

(57) ABSTRACT

One embodiment provides a method, the method including: receiving, at an information handling device, work data associated with a user; determining, based on the work data, a space assignment for the user within an environment; and assigning, utilizing a work space assignment system, the space assignment for the user with a current work condition. Other aspects are described and claimed.

### BACKGROUND

A number of companies have started to transition from a traditional work environment to a more modern-style that includes unassigned work spaces and/or desks in an open, more fluid environment. Rather than each employee having their traditional assigned area (e.g., cubicle, office, etc.), this modern-style work environment allows most employees to sit where they desire. Additionally, this type of work environment promotes working remotely, and as result, the company may reduce the number of work spaces available to a number that falls below the number of employees of the company. Thus, employees generally cannot save a work space or guarantee the same work space every time they enter the office space. Utilizing such a modern-stye work environment can save a company on expenses. Additionally, there is a thought that the more open workspace increases collaboration and creativity from employees.

### BRIEF SUMMARY

In summary, one aspect provides a method, the method including: receiving, at an information handling device, work data associated with a user; determining, based on the work data, a space assignment for the user within an environment; and assigning, utilizing a work space assignment system, the space assignment for the user with a current work condition.

Another aspect provides an information handling device, the information handling device including: a processor; a memory device that stores instructions that, when executed by the processor, causes the information handling device to: receive work data associated with a user; determine, based on the work data, a space assignment for the user within an environment; and assign, utilizing a work space assignment system, the space assignment for the user within the environment.

A further aspect provides a product, the product including: a computer-readable storage device that stores executable code that, when executed by a processor, causes the product to: receive work data associated with a user; determine, based on the work data, a space assignment for the user within an environment; and assign, utilizing a work space assignment system, the space assignment for the user within the environment.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for assigning a space for a user based on a current work condition.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Traditional workplace environments that utilize assigned seating for each employee, often see a high percentage of unutilized meeting areas and desks at any given time, particularly as more employees work remotely at least part of the time. These unutilized work areas take up real estate and ultimately cost money to provide. A way to combat a wasting of work areas is for a company and/or organization to employ a modern-style workplace that uses open or unassigned seating. At a high-level, opening up a workplace to allow employees and/or users of the open work area to sit wherever there is availability seemingly may correct this wasting of unutilized works areas. However, opening a work place and utilizing unassigned seating more commonly results in uncertainty by a user on where to sit. It may further burden a user if they desire to sit near team members and/or other users of the environment the user and there are no open seats.

Potential solutions have been implemented to assist users in finding availability of a work space with a desired preference. Whether that preference is an amenity and/or a position in relation to additional users within the environment, booking solutions allowing employees to reserve an area can permit those within an organization with flexibility regarding times in which a work area may be available. These booking solutions can also be tied back into user calendars to determine those who may be in attendance at the work area for an amount of time, and can further use occupancy sensors within specified work area to determine work space availability. Another potential solution is utilizing a method that designates an open seating area based upon designated team areas and/or neighborhoods. This method may assign a user a work space within an environment temporarily, and during the time of this assignment the user will report to the same work space position.

These potential solutions can provide a user of the environment a work space within an environment. However, these methods fail at performing the assigning of work spaces while also managing and assessing which individuals and/or teams sit proximal to one another. The lack of consideration of the position of an individual and/or a team in relation to the at least one other user present in the environment present a significant gap in studying and promoting idea flow and further collaboration among different teams with an organization. Additionally, the booking solutions do not take into account user preferences. What is needed is a system and method that can determine the best work space assignment for a user based upon work space availability within an environment, an amenity requirement, and various organizational methods to promote success within the organization.

Accordingly, the described system and method provides a technique for utilizing a work space assignment system to assign a space for a user within an environment based upon work data associated with the user and any current work conditions. The system may receive work data associated with a project and/or topic that a user is assigned to work on, data identifying a team the user belongs to, an amenity requirement in order to complete at least one step and/or portion of work assigned to the user, and the like. The work space assignment system may also take in account a variety of additional organizational metrics that may be identified in order to promote success within the company, for example, positioning an individual and/or a team proximal to at least one other user present within the environment to promote idea flow and collaboration. Additionally, the work space assignment system may take into account user preferences when assigning a space assignment to the user. Such user preferences may be inputted by a user into a user profile and/or may be learned over time by use of a machine-learning model within the system. Such a system provides an improved method of assigning a work space for a user within an environment by balancing an amount of space available within an environment, with amenity requirements and user preferences, and determined organizational metrics used to promote idea flow and completion work tasks, and therefore, success of the organization.

The illustrated example embodiments will be best understood by reference to the figures. The following description is intended only by way of example, and simply illustrates certain example embodiments.

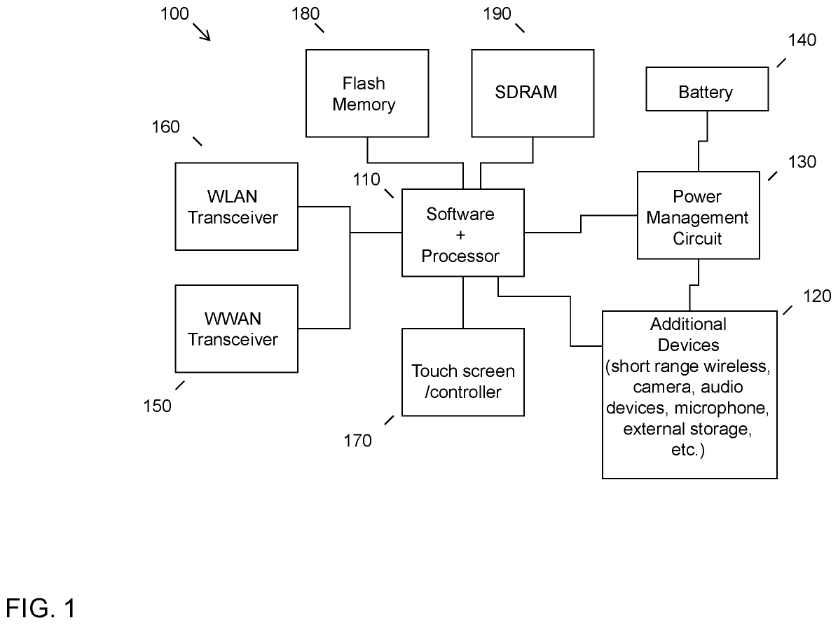

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

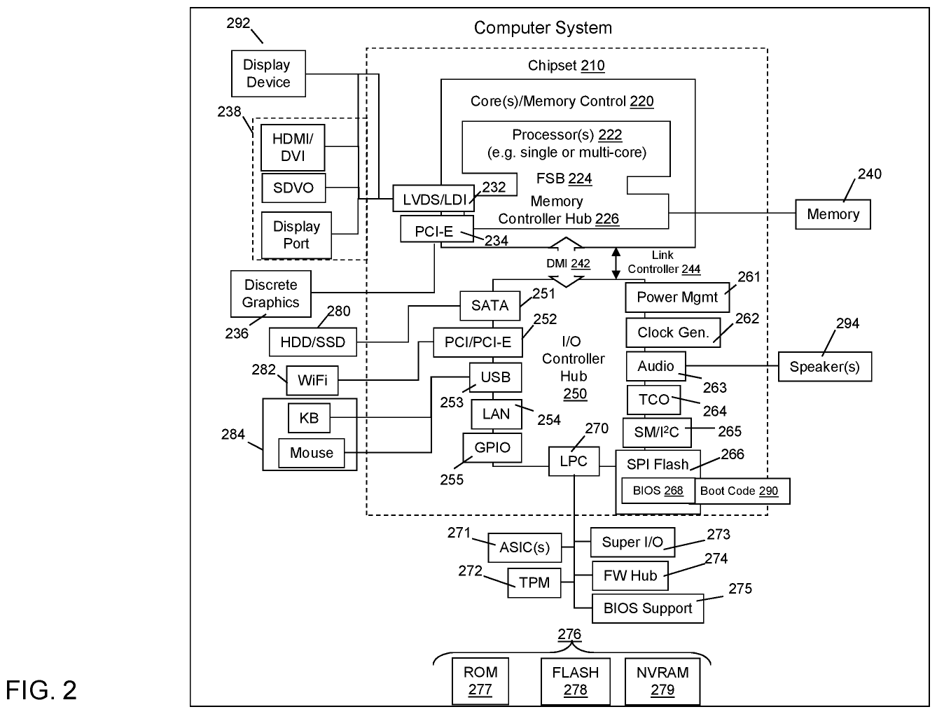

FIG. 2 depicts a block diagram of another example of information handling device circuits, circuitry or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may employ workspace assignment system and/or assign a space assignment within an environment based upon received work data. For example, the circuitry outlined in FIG. 1 may be implemented in a tablet or smart phone embodiment, whereas the circuitry outlined in FIG. 2 may be implemented in a personal computer embodiment.

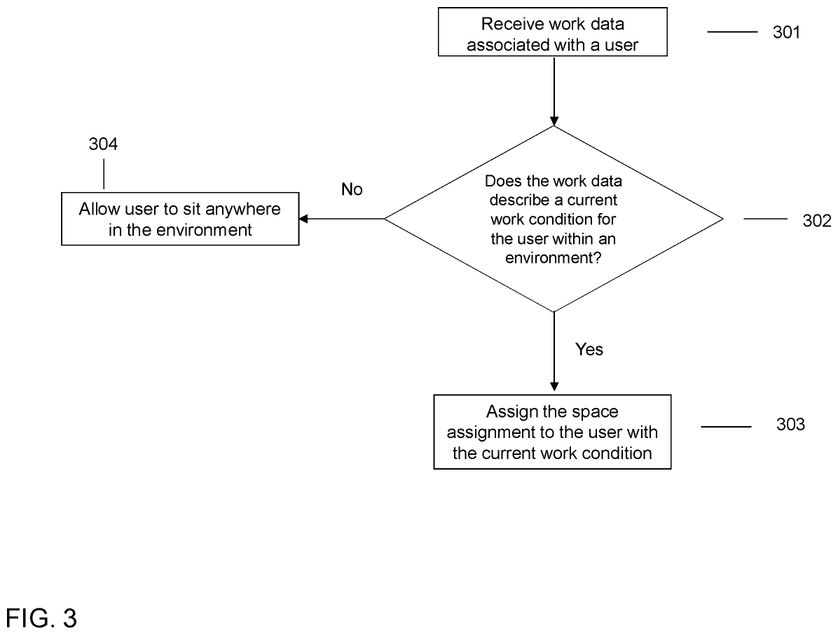

FIG. 3 illustrates an example method for assigning a space for a user within an environment based upon received work data describing a work task to be completed by the user, and additional current work conditions required in completing the work task. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to dynamically assign a space assignment for a user within an environment. Additionally, the work space assignment system includes modules and features that are unique to the described system.

Work data associated with a user can include a plurality of parameters surrounding the potential completion of a work task assigned to the user. The completion of the work task is the end goal of the user, and the parameters surrounding this end goal may include current work conditions associated with completing the task. A current work condition may range from a piece of technology required for completion of the work task (e.g., an information handling device with high-level computing power, a required application for use, etc.), to positioning a user to be near an individual and/or team members working together and/or on similar tasks, to accounting for a user preference for completing a work task (e.g., the use of an external monitor in a work space, a position of a workspace in the environment based on temperature, etc.). In the system, a current work condition associated with a user preference may be saved in a user profile that is then stored in an accessible memory device. Further, in the system, associations between a work task to be completed and the appropriate work space may also be stored in such an accessible memory device. The work data may supply the system with the information required in order to appropriately assign a user a space assignment within the environment coinciding with required current work conditions and the promoting of successful operations within an organization.

FIG. 3 provides a method for assigning a space assignment for a user based on a current work condition. At 301, the system may receive, at an information handling device in use, work data associated with the user. The information handling device associated with the system may interpret the received work data into the current work conditions associated with the work task within the work data. In other words, the system may parse received work data into a work task and at least one current work condition associated with completing the work task. For example, work data associated with a user and received by the system may determine that the user may utilize a standard-level computing device for completing the work task, but may require the user use a specific application. Additionally, the work data may further include a user preference outlining the use of an amenity, for example, an additional monitor to be present when assigning the user a work space, a particular proximity to another object (e.g., a printer, a coffee machine, a break area, etc.), and/or the like. In the system, a predetermined user preference may be provided alongside the work task present within the received work data.

Additionally, or alternatively, the user preference may be learned by the machine-learning model of the system with each space assignment for the user. The system can monitor the user within each space and identify actions that a user takes within a space. For example, the system may monitor the user and determine that a user struggles to work effectively when an external monitor is not present in the work space, but works more effectively when an external monitor is present. The system can use this information to learn that the user prefers at least one external monitor. As another example, the system may monitor the user and identify the user makes multiple trips to a break area during a work day. The system can then determine that if the user were closer to the break area, the user would spend less time walking back and forth between the work area and the break area. Thus, the system can monitor a user and learn a working style of the user. Based upon this working style, the system can identify amenities or user preferences that would assist the user in more effectively and efficiently working.

The at least one current work condition contained with the work data received at the information handling device, as described in 301, may include user associations to at least one other user present in the environment. The system may associate users together based upon similarity of work tasks between the users, team members working on a project, past success of users working together, organizational appointing of the user's based upon calculated metrics associated with idea flow and success within the organization, and the like. In the system, a current work condition describing an association of a user with at least one other user present within a work environment may be based on a determined level of success and/or productiveness between the users and/or teams in proximal locations. Conversely, the system may identify other users that cause the user to become unproductive or that result in conflict between users.

In the system, when receiving the work data associated with the user, the system may treat the receipt of the work data as the user checking-in and/or supplying their confirmation on attendance within an environment. In other words, upon receipt of work data associated with a user, the system may account for the presence of the user within the workplace environment, and thereafter proceed with assigning a space assignment for the user. If a user does not provide work data to the system, the system may not account for the user and thereafter may not assign a space assignment for the user in the environment. The receiving provides the system with work data associated with a user to be completed, as well as notifies the system to account for the user within the environment when proceeding onward to assign space assignments.

From the received work data, the system may, at 302, determine whether the work data describes or identifies a current work condition for the user within an environment. In determining if the work data describes a current work condition, at 302, the system may determine whether the current work conditions of the work task to be completed and contained within the received work data, at 301, can be met in the present work environment. In other words, the system may determine, at 302, if the current work environment has an availability and/or an open work space for the user, if the current work environment has the required technology to complete the work task within the environment, if the current work environment contains a user preference associated with an amenity within the environment, and/or the like.

When it is determined, at 302, that the received work data, at 301, contains at least one work condition that may not be met, the system may allow a user to sit anywhere in the environment, as seen at 304. For example, the system may permit the user to sit anywhere, at 304, when there is determined to not be a current work condition contained within the received work data, because the user will be able to complete the work task assigned to them without any specific requirements. In other words, the user will be able to complete a work task using standard technology and without a need of specific position proximal to additional users within an environment and/or a user preference. The system may also determine that an open work space meeting the required work conditions is not currently available, and may notify the user of such and allow the user to select an available work space. In this case, the system may also identify possible open work spaces that meet some of the requirements of the user and provide these options to the user. In providing the options, the system may rank the options, for example, based upon a number of work conditions met, a priority of work conditions, and/or the like.

Additionally, or alternatively, when the system determines that the work data does not describe a current work condition for a user within the environment, at 302, the system may further record a work space the user elects to work. Recording of the position of each user in the environment may be used to dynamically assign a space assignment within an environment to other users. For example, when another user enters the space, the system knowns what spaces are available based upon knowing which spaces are currently utilized. Further, the system may assign a space assignment to a user within a work environment even without at least one current work condition, at 304, based upon reservations and/or previous assignment of a space from received work data associated with at least one other user and/or another team of users that may be present in the environment. Accounting for all users that may have notified the system that they will be present within the environment and will need a space assignment, the system may assign a space assignment for a user with working data including no current work conditions, at 304, to ascertain that work conditions of the other users within the environment are met.

When determining that the work data does describe a current work condition for a user within an environment, at 302, the system may determine which current work conditions associated with the received work data, at 301, must be met in order to potentially provide a space assignment to the user. In the system, when determining the space assignment for the user, at 302, the system may identify a space within the environment that fulfills a current work condition associated with at least one user preference. As mentioned previously, the at least one user preference may be in relation to an amenity present of the work space, for example, an external monitor to be used when completing a work task, proximity to other objects or spaces, and/or the like.

The system may weigh amenities preferred by the user when later assigning a space assignment within the environment. The system may attempt to meet each current work condition in order to account for determined maximum productivity rate of the user. However, when the system determines that a current work condition cannot be met, conditions associated with user preference may be deemed less important to other current work conditions. In other words, the system may rank work conditions and may first identify work spaces that meet the work conditions having a higher weighting than other work conditions. In the event that not all current work conditions can be met, the system may also try to identify work spaces that meeting a greater number of work conditions than other work spaces. The system may also utilize the weighting and number of work conditions in combination.

Other work conditions may be taken into account when assigning a space assignment. Some of these conditions may be prioritized over the user preferences associated with a work space assignment. For example, the system may determine that, within the description of a current work condition in need, identifying an available space within an environment that is proximal in position to at least one other user is of greater importance than user preferences. A current work condition for a space assignment of a user to the at least one other user may be based upon a determined relationship between the users. The system may determine that the at least one other user is a team member working on the same project as the user and/or the other user is a co-worker that the user regularly interacts with on a professional level. Additionally, or alternatively, the system the assignment of a position of the user proximal to the at least one other user in the environment is based upon potential idea flow and collaboration between different users. The system may utilize a machine-learning model to produce metrics determining a success-rate of completion and/or productivity based upon user interaction. Such a machine-learning model will be described in further detail herein.

On the other hand, the system may determine, that at least one other user present in the environment may negatively impact productivity of a user, for example, via metrics produced describing low success-rate when working together, identifying a user as distracting, determining the two workers being near each other results in conflict, and/or the like. When such a situation arises within the environment, the system may elect to position the user away from the at least one user in the work environment. Additionally, or alternatively, the system may elect to position a user away from the at least one other user present in the environment upon determining that the received work data associated with each user is not related and/or communication between the users is unnecessary.

After determining that the received work data does describe a current work condition for the user within an environment, the system may move forward with assigning a space assignment for the user with the current work condition, at 303. The system may utilize a work space assignment system present to assign such a space assignment for a user with a current work condition, at 303. The work space assignment system may utilize a neural network, machine-learning model, and/or other learning algorithm, collectively referred to as a machine-learning model for ease of readability. The machine-learning model can be trained utilizing current work conditions alongside a work task present in previously received work data. In other words, the machine-learning model is given a plurality of work conditions associated with work tasks. This plurality of work conditions and associated work tasks are referred to as a training dataset. The training dataset includes a plurality of different working situations present within received work data that may be associated with a user.

Using the training dataset, which may change over time, the machine-learning model learns nuances between current work conditions and work tasks received in the work data. For example, different current work conditions, such as technology requirements, user preferences, user positioning based upon other users present in the environment, the influence on a user completing a work task, and/or the like, are associated with work tasks and/or space assignments. The trained machine-learning model can then be used to predict or infer an appropriate space assignment for a user within an environment upon receipt of work data, at 301. As space assignments are assigned in an environment and are confirmed or modified by the system, the machine-learning model of the work space assignment system can learn about new work data situations and become more accurate and refined over time. Thus, while there is an initial training dataset that is used to initially train the machine-learning model, the machine-learning model is learning over time based upon new information received, thereby ever evolving to become more accurate and make better work space assignments.

The machine-learning model of the work space assignment system may account for each type of current work condition in order to appropriately assign a space assignment for a user, at 303. Further, the system may utilize metrics produced by the machine-learning model to promote idea flow within an organization. As the machine-learning model of the work space assignment system learns and becomes more refined, historical data may be used to produce metrics associated with success within the organization. For example, historical information associated with project timelines, project quality and success, intellectual property generated, user satisfaction, user ratings of internal collaborations (e.g., peer review), and/or the like, may be utilized to determine which users and/or teams find a level of success and/or productivity when working proximal to one another within an environment. Additionally, or alternatively, the produced metrics may provide the system with combinations of individual users and/or teams that are not as successful as other combinations. Thus, the work space assignment system may account for such negative influence when assigning a space assignment for a user.

When assigning a space assignment for a user, at 303, the work space assignment system may prioritize a position of a user over at least one position of at least one other user present in the environment. The system may determine that from an available number of spaces present within an environment, the current work conditions associated with a work task of one user may be rated higher and/or of greater importance that the current work condition associated with the work task of another user. For example, the system may determine that a work task of a first user requires a high-level computing device for a single portion of a project to complete a work task, and then determine that a work task for a second user requires a high-level computing device for the entirety of their work task. If there is one high-level computing device present in the environment, the system may prioritize the second user's work condition for use of the high-level computing device because of their required need to complete a work task. Additionally, or alternatively, the system may prioritize a position of one user or another user within an environment for a variety of reasons, for example, time sensitivity, organizational rank of a user, organizational rank of a project and/or work task, and/or the like.

As the system assigns the space assignment for the user with the current work condition, at 303, the system may access a storage device and reference previous space assignments associated with a determined work task. These previous assignments may partially influence the space assignment for a user as determined by the work space assignment system. Similar to how historical information may produce metrics to predict future success, as mentioned previously, previous space assignments associated with a user may at least partially influence a position of a space assignment for the user with the current work condition. For example, the user may have a preference for maintaining a work space assignment between visits to the work place. Thus, if available, the system may attempt to assign the user to the same work space. Conversely, the user may not like a particular work space and the system may, when able, not assign the user to that work space.

Assigning the space assignment to the user with the current work condition, at 303, ultimately balances an amount of space availability within an environment, an amount of current work conditions associated with a work task requiring completion, while accounting for the determined organizational metrics to produce an appropriate space assignment for a user that further promotes idea flow and collaboration across individuals and/or teams, and therefore promotes overall success of an organization. In other words, the system attempts to optimize the work space and work space assignments based upon user preferences, increasing productivity, location of other users, organizational metrics, and/or the like.

The various embodiments described herein thus represent a technical improvement to conventional methods for improved assignment of a work space for a user within an environment by balancing an amount of space available within an environment, with amenity requirements and user preferences, and determined organizational metrics used to promote idea flow and completion work tasks, and therefore, success of the organization. The system provides a technique for utilizing a work space assignment system to assign a space assignment for a user based upon current work conditions and a determined work task. The work space assignment system permits the system to account for a variety of current work conditions associated with a work task, while simultaneously promoting positive work relationships to increase idea flow and collaboration between organizational projects containing individuals and/or teams to further the success of the organization as a whole. The work space assignment system may utilize a machine-learning model to more accurately assign a space assignment to each user within an environment with continued use.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, work data associated with a user;
determining, based on the work data, a space assignment for the user within an environment; and
assigning, utilizing a work space assignment system, the space assignment for the user with a current work condition.

2. The method of claim 1, wherein the work data associated with the user comprises information associated with a current work condition.

3. The method of claim 1, wherein the receiving the work data comprises receiving at least one user preference associated with the current work condition.

4. The method of claim 3, wherein the at least one user preference comprises an amenity for the user.

5. The method of claim 3, wherein the determining the space assignment comprises identifying a space based on at least one user preference.

6. The method of claim 1, wherein the determining the space assignment comprises identifying a space based on at least one other user present in the environment and position the user proximal to the at least one other user.

7. The method of claim 1, wherein the determining the assignment comprises identifying a space based on at least one other user present in the environment and position the user away from the at least one other user.

8. The method of claim 1, wherein the assigning the space assignment for the user comprises prioritizing a position of the user over a position of the at least one other user within the environment.

9. The method of claim 1, wherein the assigning comprises utilizing a machine-learning model.

10. The method of claim 1, wherein the assigning comprises accessing, in the storage device, previous space assignments associated with a work task, wherein the previous assignment partially influences the space assignment.

11. An information handling device, the information handling device comprising:
a processor;
a memory device that stores instructions that, when executed by the processor, causes the information handling device to:
receive work data associated with a user;
determine, based on the work data, a space assignment for the user within an environment; and
assign, utilizing a work space assignment system, the space assignment for the user within the environment.

12. The information handling device of claim 11, wherein the work data associated with the user comprises information associated with a current work condition

13. The information handling device of claim 11, wherein the receiving the work date comprises receiving at least one user preference associated with the current work condition.

14. The information handling device of claim 13, wherein the at least one user preference comprises an amenity for the user.

15. The information handling device of claim 13, wherein the determining the space assignment comprises identifying a space based on at least one the at least one user preference.

16. The information handling device of claim 11, wherein the determining the space assignment comprises identifying a space based on at least one other user present in the environment and positioning the user proximal to the at least one other user.

17. The information handling device of claim 11, wherein the determining the assignment comprises identifying a space based on a t least one other user present in the environment and position the user away from the at least one other user.

18. The information handling device of claim 11, wherein the assigning the space assignment for the user comprises prioritizing a position of the user over a position of the at least on other user within the environment.

19. The information handling device of claim 11, wherein the assigning comprises accessing, in the storage device, previous space assignments associated with a work task, wherein the previous assignment partially influences the space assignment.

20. A product, the product comprising:
a computer-readable storage device that stores executable code that, when executed by the processor, causes the product to:
receive work data associated with a user;
determine, based on the work data, a space assignment for the user within an environment; and
assign, utilizing a work space assignment system, the space assignment for the user within the environment.
